(19) United States
(12) Patent Application Publication
(10) Pub. No.: US 2004/0074583 A1
(43) Pub. Date: Apr. 22, 2004

(54) Method of wrapping a sandwich in a heat sealable sandwich wrap

(75) Inventors: Rebecca E. Whitmore, Chilton, WI (US); Debra D. Bowers, Menasha, WI (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(73) Assignee: FORT JAMES CORPORATION

(21) Appl. No.: 10/686,328

(22) Filed: Oct. 14, 2003

Related U.S. Application Data
(62) Division of application No. 09/635,358, filed on Aug. 9, 2000.
(60) Provisional application No. 60/149,179, filed on Aug. 17, 1999.

(51) Int. Cl. A44B 19/00; A41H 37/00; B32B 7/12; B32B 15/04

(52) U.S. Cl. 156/66; 428/343

(57) ABSTRACT

A sandwich wrap includes a heat seal coating which, after a sandwich has been wrapped into a package, and heat has been applied to the heat seal coating, produces a seal that prevents the package from accidentally becoming unwrapped during handling. A portion of the wrap located remotely of the heating surface remains unsealed, and can be peeled away to gain access to the sandwich.

### PRIOR APPLICATION

This application is a divisional of U.S. application Ser. No. 09/635,358, filed on Aug. 9, 2000, which claims the benefit of provisional application Serial No. 60/149,179 filed Aug. 17, 1999, both of which are incorporated herein by reference.

### BACKGROUND OF THE INVENTION

The present application pertains to a sandwich wrap and to a method of wrapping sandwiches.

Food products, such as sandwiches, that are sold in fast food-type of restaurants are typically packaged in one of several different types of packages to protect the food product until it is consumed. One type of package involves the use of flat paper sheet wrap. The sandwich is placed on a flat paper sheet which is then folded around the sandwich. The paper sheet is typically held in place by tucking the end flaps of the sheet under the sandwich. The wrapped sandwich can then be placed in a storage bin for future sale or may be placed in a bag for being carried out of the restaurant.

It has been found, however, that when the packaged sandwich is placed in a storage bin for later sale or in a bag for transportation and later consumption, the paper sheet wrap has a tendency to come unwrapped. Thus, the contents of the sandwich may spill-out, creating untidy and unsanitary conditions.

Cold seal cohesives and pressure sensitive adhesives have been tested as methods for sealing wrapped sandwiches. They all have the disadvantage of potentially sticking together when they are not intended to, as when a pressure sensitive adhesive surface comes in contact with any other surface, or when one cohesive surface is accidentally placed in contact with another.

Therefore, it would be desirable to provide a sandwich wrap which prevents accidental unwrapping, without the problems of the types described above.

### SUMMARY OF THE INVENTION

The invention pertains to a wrapped sandwich around which the sheet of flexible material has been wrapped such that the heat sealable substance is heat sealed to a portion of the folded sheet to resist unfolding of the sheet.

The invention also pertains to a method of wrapping a sandwich using the above-described sheet, the method comprising the steps of:

A) placing the sandwich on the sheet;

B) folding the sheet around the sandwich such that at least a portion of the heat sealable substance contacts another part of the folded sheet; and

C) heating that portion of the heat sealable substance to form a heat seal with the part of the sheet that it contacts.

The heating of the heat sealable substance can be accomplished by applying heat from outside of the wrapped sandwich, such as by placing the wrapped sandwich on a hot plate. Alternatively, the heating of the heat sealable substance can be accomplished by applying heat from within the wrapped sandwich, such as by wrapping a hot sandwich.

It is not necessary for all of the heat sealable substance to be heated and placed in heat seal relationship with the rest of the sheet in order to sufficiently prevent the folded wrap from becoming accidentally unfolded.

### BRIEF DESCRIPTION OF THE DRAWINGS

The objects and advantages of the invention will become apparent from the following detailed description of preferred embodiments thereof in connection with the accompanying drawings in which like numerals designate like elements and in which:

FIG. 1 is a top plan view of a sandwich wrap according to the invention;

FIG. 2 is a view similar to FIG. 1 after a sandwich has been placed on the wrap;

FIG. 3 is a side view of FIG. 2;

FIG. 4 is a view similar to FIG. 2 after the wrap has been initially folded around the sandwich;

FIG. 5 is a side view of FIG. 4;

FIG. 6 is a view similar to FIG. 4 after ends of the wrap have been folded to form end flaps;

FIG. 7 is a side view of FIG. 6;

FIG. 8 is a view similar to FIG. 6 after the end flaps have been tucked under the sandwich;

FIG. 9 is a side view of FIG. 8.

FIG. 10 is a side view similar to FIG. 9 with the wrapped package seated on a heated surface;

FIG. 11 is a bottom view of the final package;

FIG. 12 is a side view of the final package;

FIG. 13 is a view, similar to FIG. 1, of another embodiment of the present invention; and

FIGS. 14-16 are views depicting the use of the embodiment of FIG. 13.

### DETAILED DESCRIPTION OF THE PREFERRED EMBODIMENTS OF THE INVENTION

Depicted in FIG. 1 is a sheet 10 of a sandwich wrap that comprises a substrate 11 coated on one side with a heat sealable coating 12, i.e., a material that becomes adhesive only when heated to a certain temperature. The substrate 11 can be any type of material that is flexible enough to be folded around a sandwich, such as paper, or polymer film, or a multi-ply sheet formed of paper and polymer plies. The heat sealable coating 12 can comprise any suitable type coating, such as hot melt adhesives, water dispersed acrylics or EAA's (ethylene acrylic acid), etc. The coating 12 can be applied over any part or all of the side of the sheet. In FIG. 1 the coating 12 is shown as applied as a peripheral edge band. Alternatively, other portions, or the entire side could be so coated.

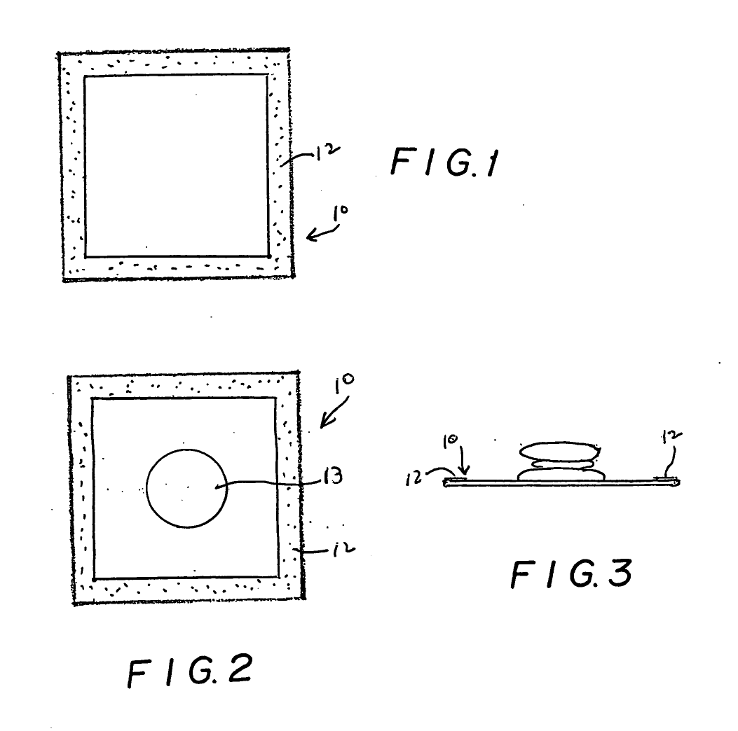

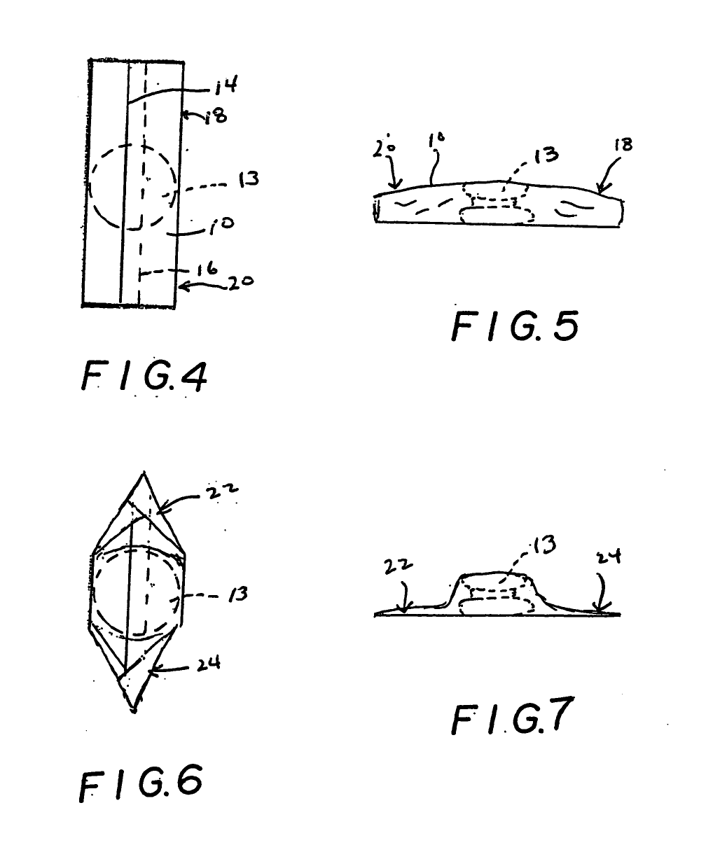

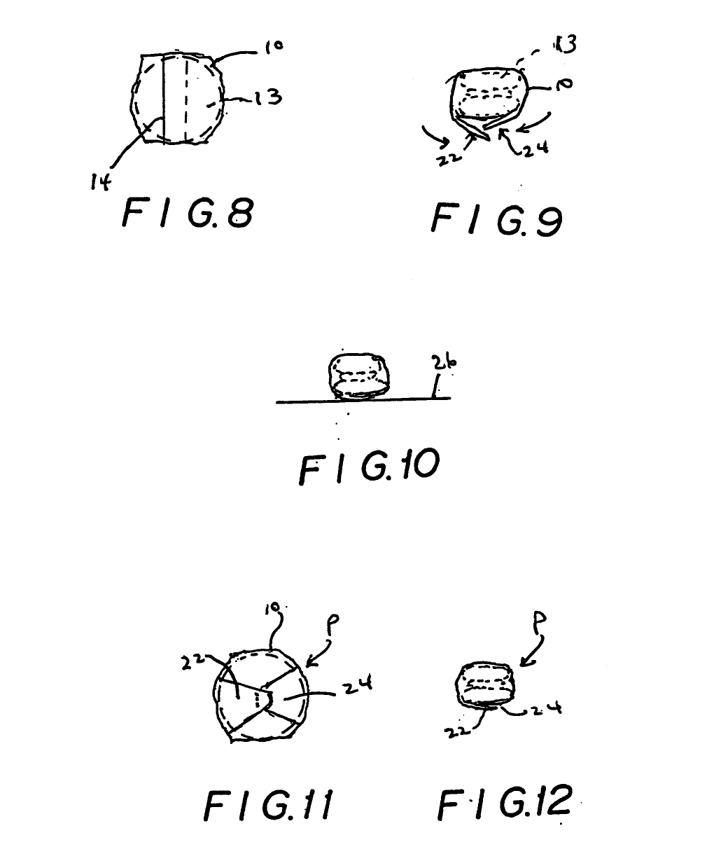

In use, the sandwich is placed on the wrap, i.e. on the side having the coating or on the other side. Then, the wrap is folded around a sandwich 13 in any conventional manner, such as by the methods described below. In FIGS. 2-9 a first technique is depicted wherein the wrap is folded along its center so that opposite edges 14, 16 of the wrap come into overlapping relationship on top of the sandwich, with the wrap now forming opposing ends 18, 20 extending past the sandwich (see FIGS. 4 and 5). The edges of each of those ends are now folded together to form end flaps 22, 24 as shown in FIGS. 6 and 7. The end flaps 22, 24 are then tucked beneath the sandwich as depicted in FIGS. 8 and 9.

The sandwich is then placed upon a heated surface 26 which is sufficiently hot to cause the coating 12 to become adhesive. (This effect can be assisted by heat from the sandwich if a heated sandwich is being wrapped.) For example, some fast food restaurants typically include hot plates or heated surfaces on which hot sandwiches, such as hamburgers, are kept until being given to a customer. Such heated surfaces can be, e.g., 120° F. which is hot enough to make the coating 12 become adhesive.

After a matter of only seconds on such a heated surface, the adhesive closest to the heated surface is activated, causing each of the folded flaps 22, 24 to seal itself up, resulting in a sealed package P, see FIGS. 11 and 12.

The thus-sealed package P can be placed in a bag for removal from the restaurant. The package will not open during insertion or removal from the bag, keeping the sandwich contents sanitary and neatly arranged.

The sealed package can be easily opened, because a top portion of the wrap remote from the heated surface, which includes the edge 14 (see FIG. 8), will not have become sealed together. Instead, that portion can be peeled away, to gain access to the sandwich inside.

Furthermore, when a portion of the wrap is peeled away, the remaining portion forms a pouch which helps keep the sandwich contents intact during consumption. This allows the customer to gain access to the wrapped sandwich easily and consume the sandwich with one hand if necessary, such as during the driving of a car.

Depending upon the bond strength of the chosen adhesive, the seal can be made permanent (requiring that the wrap be torn to release the sealed flaps), or the seal can be made releasable with pulling pressure. Also, the temperature of activation can be regulated by the choice of adhesive.

In one example of a sandwich wrap according to the invention a metallized polyester #70 gauge film was coated completely on one side thereof with a heat seal adhesive in the form of a water based acrylic coating. A sandwich was wrapped in the film in the manner described in connection with FIGS. 2-9, and the bottom portion of the wrapped package was placed for five seconds on a plate heated to 225° F. When the package was removed, each of the end flaps was sealed internally, i.e., to itself, but not to the other end flap. The top part of the film was not sealed and was easily peeled away. When the above steps were repeated, except that the package was held against the heated surface for ten seconds, each of the end flaps was not only sealed internally, but was sealed to the other end flap.

When the temperature was increased to 250° F., the end flaps were sealed internally and to each other regardless of whether the package was held against the heated surface for 5 or 10 seconds.

In all cases, the top portion of the wrap did not seal and could be easily peeled away.

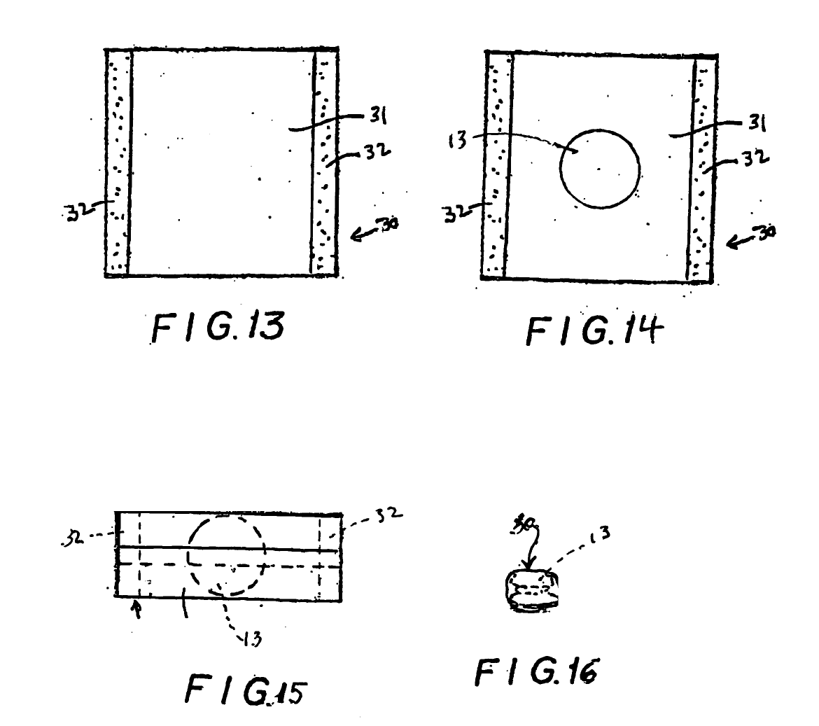

In another preferred embodiment of the invention, depicted in FIGS. 13-16, a sandwich wrap 30 has a heat seal arrangement which is activated by the heat of a hot sandwich, thereby eliminating the need for a hot surface. It has been found that such a concept of utilizing heat for the sandwich to create a heat seal could be used with the sheet described in connection with FIGS. 1-7, the concept works better when the heat seal 32 is applied along only two opposing edges of the substrate 31, as shown in FIG. 13. The two edges most preferably constitute the edges which are overlapped when the sheet is wrapped around the sandwich 13 (i.e., the edges correspond to the edges 14 and 16 of FIG. 4). The end flaps will become sealed as a result of the heat and pressure produced by the sandwich.

In all embodiments of the invention, it may be desirable to coat, with a conventional release agent, the side of the substrate that does not have the heat sealable coating 12, in order to prevent the coating 12 of each wrap from adhering to other wraps during shipping (e.g., in the event that the wrap temperature becomes high, enough to activate the heat sealable coating during shipment of the wraps).

Although the present invention has been described in connection with preferred embodiments thereof, it will be appreciated by those skilled in the art that additions, deletions, modifications, and substitutions not specifically described may be made without departing from the spirit and scope of the invention.

What is claimed is:

1. A method of wrapping a sandwich comprising the steps of:
A) placing the sandwich on a flexible sheet having a heat sealable substance coated on at least a portion of a side thereof;
B) folding the sheet around the sandwich such that at least a portion of the heat-sealable substance contacts another part of the folded sheet; and
C) heating that portion of the heat sealable substance to form a heat seal with the part of the sheet that it contacts.

2. The method according to claim 1 wherein step C comprises applying heat from outside of the wrapped sandwich.

3. The method according to claim 2 wherein step C comprises placing the wrapped sandwich on a hot plate.

4. The method according to claim 1 wherein step C comprises applying heat from within the wrapped sandwich by wrapping a hot sandwich.

5. The method according to claim 1 wherein step C comprises causing less than all of the heat sealable substance to be heated sufficiently to produce a heat seal.

6. The method according to claim 1 wherein step A further comprises placing the sandwich on a sheet having the heat sealable substance coated along at least one edge thereof.

7. The method according to claim 1 wherein steps A and B are performed manually.

8. A method of wrapping a sandwich comprising the steps of:
A) placing the sandwich on a flexible sheet including a heat sealable coating on a first portion thereof;
B) wrapping the sheet around the sandwich such that the heat sealable coating at least partially contacts a second portion of the flexible sheet; and
C) heating at least part of the heat sealable coating to at least partially adhere the first portion of the flexible sheet to the second portion of the flexible sheet.

9. The method according to claim 8 wherein step C comprises applying external heat to the heat sealable coating.

10. The method according to claim 9 wherein step C comprises placing the wrapped sandwich on a hot plate.

11. The method according to claim 8 wherein step C comprises applying heat to the heat sealable coating by wrapping a hot sandwich.
